(19) United States
(12) Patent Application Publication
(10) Pub. No.: US 2012/0256975 A1
(43) Pub. Date: Oct. 11, 2012

(54) LIQUID CRYSTAL DISPLAY DEVICE AND DRIVE METHOD OF LIQUID CRYSTAL DISPLAY DEVICE

(75) Inventor: Shinji Yukawa, Osaka-shi (JP)

(73) Assignee: SHARP KABUSHIKI KAISHA, Osaka-shi, Osaka (JP)

(21) Appl. No.: 13/515,504

(22) PCT Filed: Aug. 11, 2010
(86) PCT No.: PCT/JP10/63642

§ 371 Date: Jun. 13, 2012

(30) Foreign Application Priority Data
Dec. 18, 2009 (JP) 2009-288447

(51) Int. Cl. G09G 5/10; G09G 3/36

(52) U.S. Cl. 345/690; 345/87; 345/88

(57) ABSTRACT

The present invention realizes a liquid crystal display device which can carry out overshoot driving in accordance with a picture element area. Picture elements can be classified into types depending on their picture element areas such that, in a case where display of a first tone (T0) by picture elements is shifted to a second tone (T1) different from the first tone through a plurality of frames, within a range of input tone data corresponding to the first tone and a range of input tone data corresponding to the second tone, a picture element of a type with a larger picture element area exhibits a larger difference in electric potential of a data signal corresponding to display of the second tone between an initial frame (F1) out of the plurality of frames and frames during which display is in a steady state (T1) out of the plurality of frames.

### TECHNICAL FIELD

The present invention relates to a liquid crystal display device which carries out data processing for controlling a response speed of liquid crystal.

### BACKGROUND ART

In a liquid crystal display device, when a voltage is applied to a liquid crystal layer, there occurs a delay in response until orientation of liquid crystal molecules is changed. In order to compensate such a delay in response, overshoot driving has been widely used. The overshoot driving is a technique to correct display data by the use of a liquid crystal controller, such that a response speed of liquid crystal molecules is heightened, by emphasizing tone information, contained in the display data, in order to carry out a display with an intended tone.

For example, (i) a frame memory 101 and a look-up table 102 are provided in a liquid crystal controller, (ii) pieces of current frame display data CFD of respective R, G, B, and Y are corrected to include overshooting amounts with reference to the look-up table 102 and thus converted into pieces of target data TD of respective R, G, B, and Y, and (iii) the pieces of current frame display data CFD are stored in the frame memory 101 (see FIG. 5). In a case where the pieces of current frame display data CFD of respective R, G, B, and Y are converted into the pieces of target data TD of respective R, G, B, and Y with reference to the look-up table 102, the overshooting amounts to be applied to the current frame are determined by referring to pieces of previous frame display data PFD of respective R, G, B, and Y which have been stored in the frame memory 101.

Note that a response speed of liquid crystal heavily depends on a temperature of the liquid crystal itself. In a case of a low temperature, in particular, the response speed is significantly deteriorated. As liquid crystal display devices become larger in recent years, there occurs a growing problem of unevenness in temperature of liquid crystal itself, in a display region of a liquid crystal display device.

Patent Literature 1 discloses a configuration in which overshoot driving is carried out in accordance with such a temperature variation.

FIG. 6 illustrates a configuration of a display device disclosed in Patent Literature 1.

The display device includes a driving device 70. Temperature sensors 30 are provided for pixels in a display panel 2. In order to compensate a response speed of liquid crystal based on temperature information of the liquid crystal obtained by the temperature sensors 30, data generating sections A through D, which are provided in the driving device 70 and generate data for overshoot driving, are selectively used in accordance with temperature.

According to the technique disclosed in Patent Literature 1, a plurality of temperature sensors 30 are provided in a display screen, and therefore overshoot driving can be carried out while taking into consideration temperature variation in the display region.

### CITATION LIST

### Patent Literature

### [Patent Literature 1]

Japanese Patent Application Publication Tokukai No. 2005-215059 A (Publication date: Aug. 11, 2005)

### SUMMARY OF INVENTION

### Technical Problem

Conventionally, there has been a liquid crystal display device which carries out overshoot driving by the use of a configuration (as is disclosed in Patent Literature 1) for compensating variation in responsivity of liquid crystal, which variation is caused due to a difference in temperature. However, there has not existed a liquid crystal display device which compensates variation in responsivity of liquid crystal, which variation is caused due to a difference in size of a picture element.

In a case where, for example, (i) a liquid crystal display device has picture elements of red (R), green (G), blue (B), and yellow (Y), and (ii) each of the red and blue picture elements is larger in area than each of the green and yellow picture elements, an incorrect color balance is caused when a moving image is displayed.

In a case where each of the red and blue picture elements has a picture element area different from that of each of the green and yellow picture elements, a capacity load, which is connected with a drain of a TFT provided as a switching element in each of the picture elements, becomes larger in each of the red and blue picture elements, having the larger picture element area, than in each of the green and yellow picture elements. Under the circumstances, in a case where the picture elements are charged with identical voltages for identical periods of time, a delay in response of liquid crystal molecules becomes larger in each of the red and blue picture elements than in each of the green and yellow picture elements. Therefore, in a case where (i) overshoot driving is carried out with respect to the picture elements such that a voltage, which is larger than a voltage corresponding to a steady state of a display, is applied to a liquid crystal layer during a first frame and (ii) the voltage corresponding to the steady state is applied to the liquid crystal layer during a second frame and subsequent frames (see dotted lines indicating “OS function ON” in (a) of FIG. 7), each of the green and yellow picture elements is affected by the overshooting greater than each of the red and blue picture elements (see (b) of FIG. 7). This causes the incorrect color balance because white balance is no longer maintained.

In a case where, for example, a gray bar having a halftone is displayed and scrolled on a gray-scale background image, incorrect color balance is caused in a part 201 of the gray bar (see FIG. 8).

The present invention is accomplished in view of the conventional problem, and its object is to realize (i) a liquid crystal display device which carries out overshoot driving in accordance with a picture element area and (ii) a method for driving the liquid crystal display device.

### Solution to Problem

In order to attain the object, a liquid crystal display device of the present invention, which is a liquid crystal display device of an active matrix type, includes picture elements having different picture element areas in a display region, the picture elements being classified into a plurality of types depending on their picture element areas, in a case where display of a first tone by the picture elements is shifted to display of a second tone different from the first tone through a plurality of frames, within a range of input tone data corresponding to the first tone and a range of input tone data corresponding to the second tone, a picture element of a type with a larger picture element area exhibits, with respect to each data polarity, a larger difference in electric potential of a data signal corresponding to display of the second tone between an initial frame out of the plurality of frames and frames during which display is in a steady state out of the plurality of frames.

According to the configuration of the present invention, a picture element of a type with a larger picture element area receives a data signal corrected by adding thereto a larger overshooting amount, and a liquid crystal application voltage, corresponding to thus corrected data signal, is applied to liquid crystal corresponding to the picture element. With the configuration, it is possible to causes liquid crystal molecules corresponding to different types of picture elements to have approximate or identical response speeds, and it is therefore possible to obtain substantially uniform response speeds in all types of picture elements in their display states. This allows suppression in the incorrect color balance when a gray display is carried out by a multicolor liquid crystal display device. Moreover, with the configuration of the present invention, it is possible to prevent time lag of tone change in a transient response, by controlling the liquid crystal molecules to have substantially uniform response speeds in all the picture elements. The present invention is therefore applicable to a simple color liquid crystal display device.

This brings about an effect of realizing a liquid crystal display device which can carry out overshoot driving in accordance with a picture element area.

In order to attain the object, a method of the present invention for driving a liquid crystal display of an active matrix type, which includes picture elements having different picture element areas in a display region, includes the step of: setting a relation among (i) first input tone data corresponding to a first tone, (ii) second input tone data corresponding to a second tone, and (iii) a difference in electric potential of a data signal corresponding to display of the second tone between an initial frame out of the plurality of frames and frames during which display is in a steady state out of the plurality of frames, in such a manner that the picture elements are classified into a plurality of types depending on their picture element areas, the classification of the picture elements being carried out such that, in a case where display of the first tone by the picture elements is shifted to display of the second tone different from the first tone through a plurality of frames, a picture element of a type with a larger picture element area exhibits, with respect to each data polarity, a larger difference in electric potential of the data signal corresponding to display of the second tone between the initial frame out of the plurality of frames and the frames during which display is in a steady state out of the plurality of frames.

According to the method of the present invention, a picture element of a type with a larger picture element area receives a data signal corrected by adding thereto a larger overshooting amount, and a liquid crystal application voltage, corresponding to thus corrected data signal, is applied to liquid crystal corresponding to the picture element. With the configuration, it is possible to causes liquid crystal molecules corresponding to different types of picture elements to have approximate or identical response speeds, and it is therefore possible to obtain substantially uniform response speeds in all types of picture elements in their display states. This allows suppression in the incorrect color balance when a gray display is carried out by a multicolor liquid crystal display device. Moreover, with the method of the present invention, it is possible to prevent time lag of tone change in a transient response, by controlling the liquid crystal molecules to have substantially uniform response speeds in all the picture elements. The present invention is therefore applicable to a simple color liquid crystal display device.

This brings about an effect of realizing a method for driving a liquid crystal display device which can carry out overshoot driving in accordance with a picture element area.

### Advantageous Effects of Invention

As above described, the liquid crystal display device of the present invention is a liquid crystal display device of an active matrix type, the liquid crystal display device including picture elements having different picture element areas in a display region, the picture elements being classified into a plurality of types depending on their picture element areas, in a case where display of a first tone by the picture elements is shifted to display of a second tone different from the first tone through a plurality of frames, within a range of input tone data corresponding to the first tone and a range of input tone data corresponding to the second tone, a picture element of a type with a larger picture element area exhibits, with respect to each data polarity, a larger difference in electric potential of a data signal corresponding to display of the second tone between an initial frame out of the plurality of frames and frames during which display is in a steady state out of the plurality of frames.

This brings about an effect of realizing a liquid crystal display device which can carry out overshoot driving in accordance with a picture element area.

As above described, the method of the present invention for driving a liquid crystal display device is a method for driving a liquid crystal display device of an active matrix type, the liquid crystal display device including picture elements having different picture element areas in a display region, the method including the step of: setting a relation among (i) first input tone data corresponding to a first tone, (ii) second input tone data corresponding to a second tone, and (iii) a difference in electric potential of a data signal corresponding to display of the second tone between an initial frame out of the plurality of frames and frames during which display is in a steady state out of the plurality of frames, in such a manner that the picture elements are classified into a plurality of types depending on their picture element areas, the classification of the picture elements being carried out such that, in a case where display of the first tone by the picture elements is shifted to display of the second tone different from the first tone through a plurality of frames, a picture element of a type with a larger picture element area exhibits, with respect to each data polarity, a larger difference in electric potential of the data signal corresponding to display of the second tone between the initial frame out of the plurality of frames and the frames during which display is in a steady state out of the plurality of frames.

This brings about an effect of realizing a method for driving a liquid crystal display device which can carry out overshoot driving in accordance with a picture element area.

### BRIEF DESCRIPTION OF DRAWINGS

FIG. 1 is an explanatory view for explaining overshoot driving in accordance with an embodiment of the present invention. (a) of FIG. 1 is a waveform chart illustrating liquid crystal application voltages when overshoot driving is carried out, and (b) of FIG. 1 is a graph illustrating responses of liquid crystal transmittance when overshoot driving is carried out.

FIG. 2 is a block diagram illustrating a configuration of an overshooting correction block, in accordance with an embodiment of the present invention.

FIG. 3 is a block diagram illustrating a configuration of a liquid crystal display device, in accordance with an embodiment of the present invention.

FIG. 4 is an explanatory view for explaining pixels and picture elements included in the liquid crystal display device. (a) of FIG. 4 is a plane view illustrating an arrangement of the pixels and the picture elements included in the liquid crystal display device shown in FIG. 3, and (b) of FIG. 4 is a circuit diagram illustrating a configuration of the picture element shown in (a) of FIG. 4.

FIG. 5 is a block diagram illustrating a configuration of a conventional overshooting correction block.

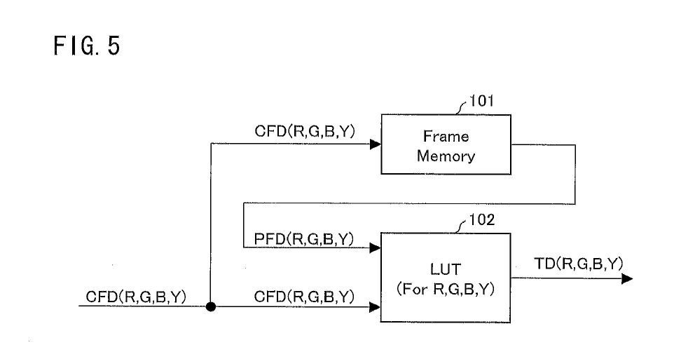

FIG. 6 is a block diagram illustrating a configuration of a conventional display device.

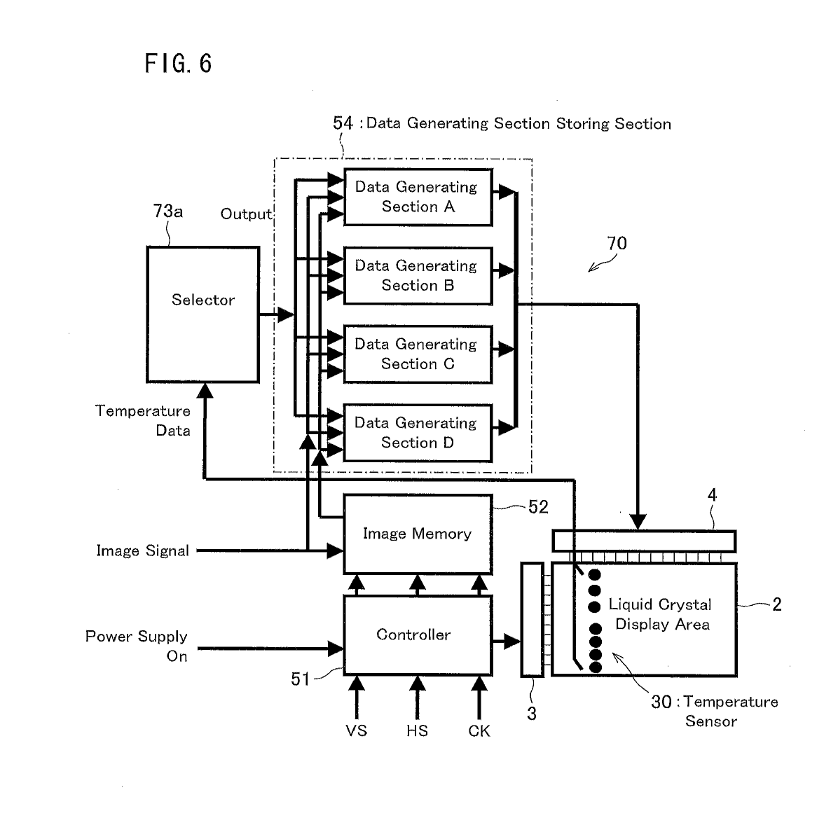

FIG. 7 is an explanatory view for explaining conventional overshoot driving. (a) of FIG. 7 is a waveform chart illustrating liquid crystal application voltages when overshoot driving is carried out, and (b) of FIG. 7 is a graph illustrating responses of liquid crystal transmittance when overshoot driving is carried out.

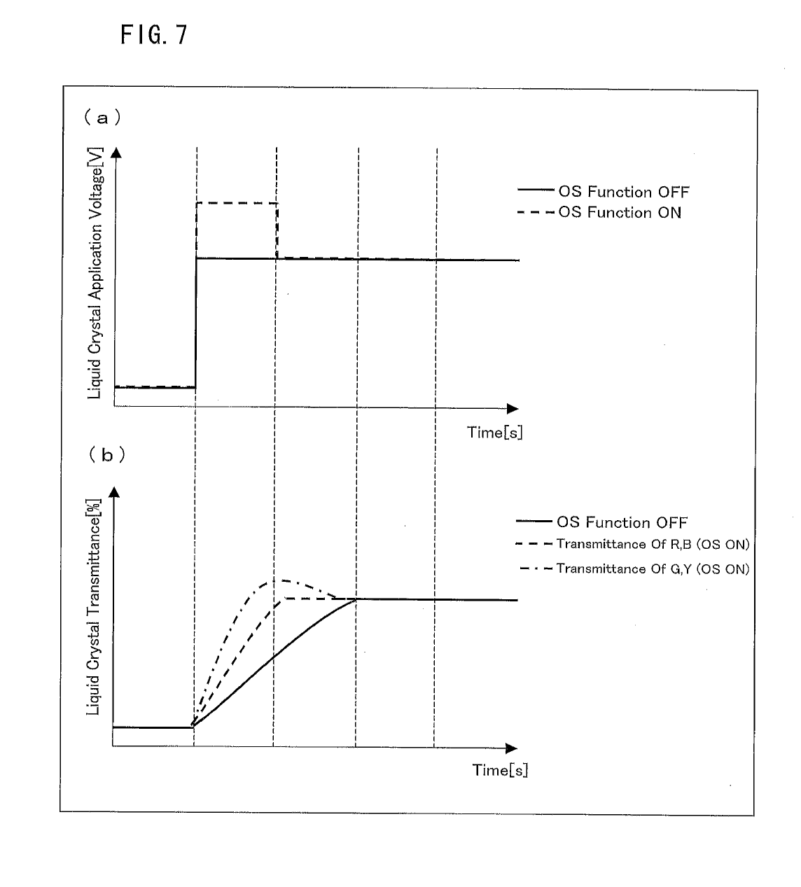

FIG. 8 is an explanatory view for explaining incorrect color balance in a conventional technique.

### DESCRIPTION OF EMBODIMENTS

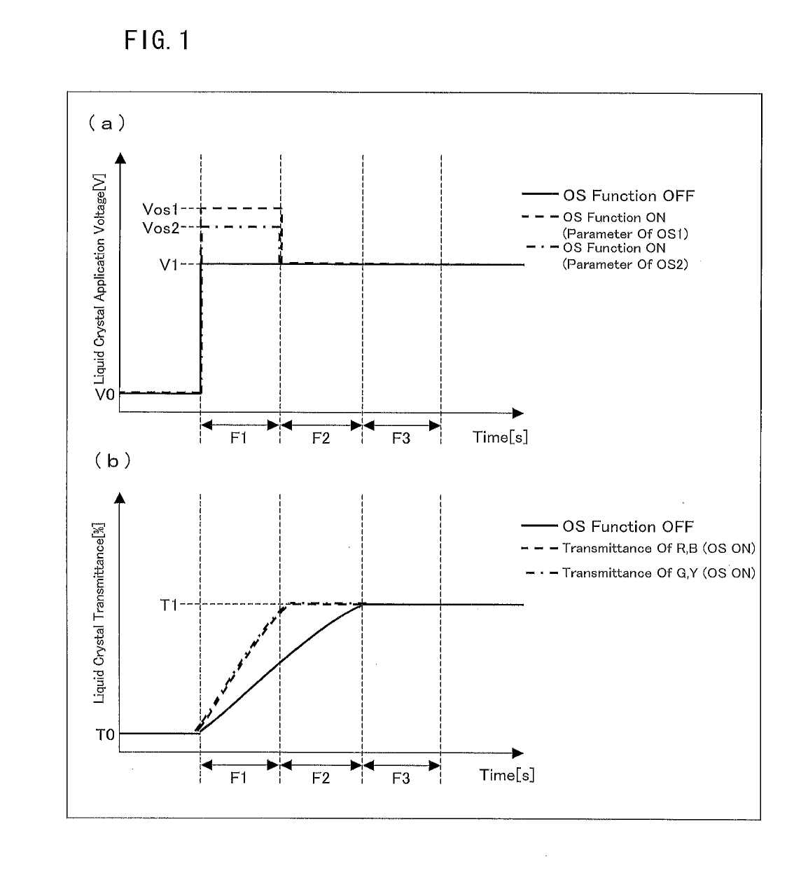

The following description will discuss an embodiment of the present invention, with reference to FIGS. 1 through 4.

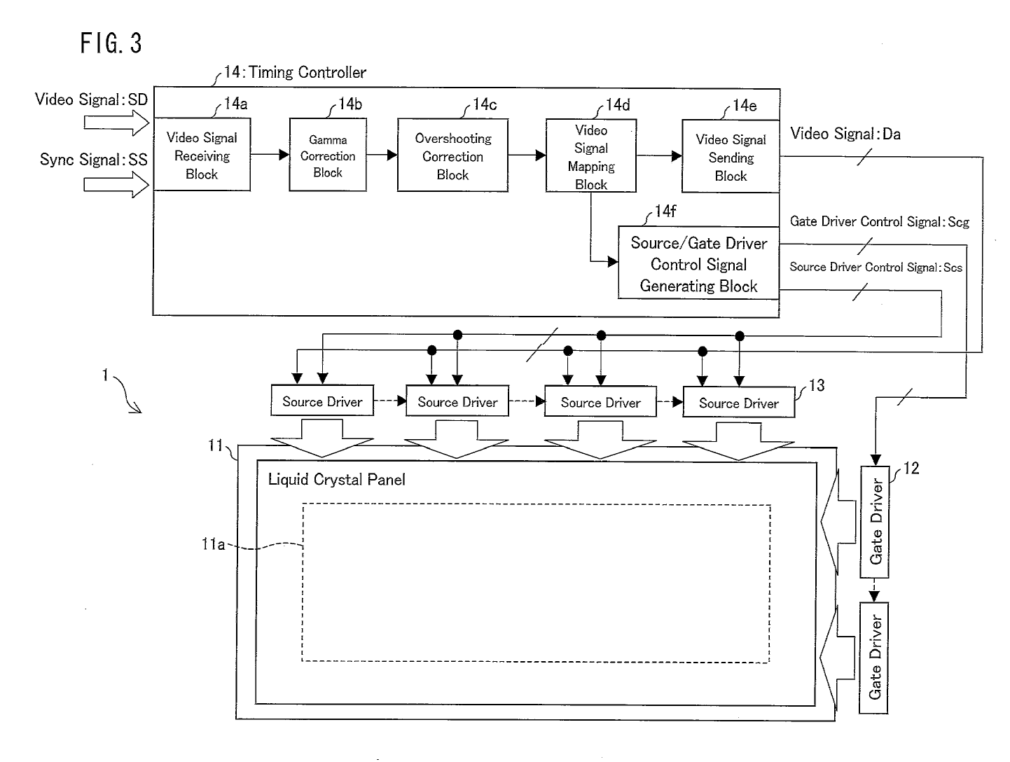

FIG. 3 is a block diagram illustrating a configuration of a liquid crystal display device 1 of the present embodiment.

The liquid crystal display device 1 is an active matrix display device including a liquid crystal panel 11, gate drivers 12, source drivers 13, and a timing controller 14.

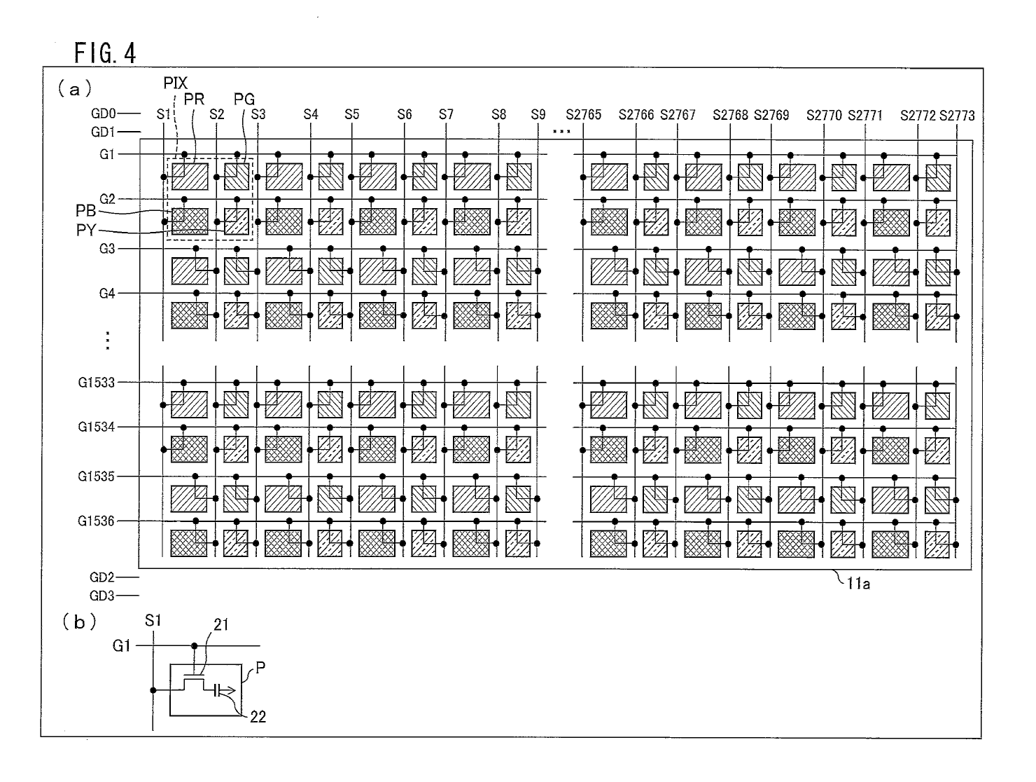

The liquid crystal panel 11 is manufactured by the use of materials such as amorphous silicon, polycrystalline silicon, CG silicon, and microcrystalline silicon. The liquid crystal panel 11 has a basic configuration in which (i) a TFT substrate (matrix substrate) on which a matrix circuit is formed by the use of various silicon materials above exemplified and (ii) a counter substrate are bonded with each other such that a liquid crystal layer is provided between the TFT substrate and the counter substrate. The liquid crystal panel 11 further includes members such as a backlight and a polarizing plate. The liquid crystal panel 11 has a display region 11a in which picture elements are arranged in a matrix manner so as to be at respective intersections of gate lines and source lines. The picture element can have an arbitrary color, regardless of whether the picture element is included in a multicolor or single color liquid crystal display device. The picture elements can be, for example, a red (R) picture element, a green (G) picture element, a blue (B) picture element, and a yellow (Y) picture element (see (a) of FIG. 4).

(a) of FIG. 4 shows an example in which (i) vertical m picture elements×horizontal n picture elements are arranged (here, m=1536 and n=2772) and (ii) one (1) pixel PIX is made up of a red picture element PR, a green picture element PG, a blue picture element PB, and a yellow picture element PY. The red picture element PR corresponds to an h-th (h is an odd number) gate line Gh and a k-th (k is an odd number) source line Sk. The green picture element PG corresponds to the gate line Gh and a k+1th source line S(k+1). The blue picture element PB corresponds to an h+1th gate line G(h+1) and the source line Sk. The yellow picture element PY corresponds to the gate line G(h+1) and the source line S(k+1). Namely, the display region 11a has a matrix of (m/2) pixel rows×(n/2) pixel columns (here, 768 pixel rows×1386 pixel columns). Note that dummy driving lines, which are not connected with any effective display pixels, are provided as appropriate. Examples of such dummy driving lines encompass (i) gate lines GD0 and GD1 which are provided on an upper side with respect to a gate line G1, (ii) gate lines GD2 and GD3 which are provided on a lower side with respect to a gate line Gm (here, m=1536), and (iii) a source line SN which is provided on a further side with respect to a source line Sn (N>n, here, N=2773) (see (a) of FIG. 4).

Moreover, in the configuration illustrated in (a) of FIG. 4, each of the red picture element and the blue picture element is larger in size than each of the green picture element and the yellow picture element. It is assumed, as an example, that (i) the red picture element PR and the blue picture element PB have identical picture element areas and (ii) the green picture element PG and the yellow picture element PY have identical picture element areas. Each of the picture elements (represented by a picture element P shown in (b) of FIG. 4, which corresponds to the picture element PR) has (i) a TFT 21 serving as a switching element and (ii) a picture element capacitor 22 made up of an integrated capacitor containing capacitors such as a liquid crystal capacitor, a storage capacitor, and a parasitic capacitor. As the picture element P has a larger picture element area, capacitance of the picture element capacitor 22 becomes larger in accordance with an increase mainly in liquid crystal capacitance and in storage capacitance. The TFT 21 has (i) a gate connected with a gate line Gi, (ii) a source connected with a source line Sj, and (iii) a drain connected with a picture element electrode constituting one terminal of the picture element capacitor 22. The picture element capacitor 22 and the picture element electrode itself serve as capacitive loads on the drain. The TFT 21 has a size (i.e., a gate length L and a gate width W) common to all the picture elements. Therefore, the picture elements PR and PB apply greater loads on drains of their TFTs 21, as compared to the picture elements PG and PY.

The gate drivers 12 constitute a driving circuit for driving pixel rows, in which driving circuit the gate drivers 12 are cascade-connected with each other. The gate drivers 12 are provided in the vicinity of an edge of the liquid crystal panel 11 in the form of, for example, COG (Chip On Glass) or COF (Chip On Film). The gate drivers 12 receive, from the timing controller 14, respective gate driver control signals Scg each indicative of a gate clock, a gate start pulse, and the like, and sequentially supply, in response to the gate driver control signals Scg, gate pulses to the respective gate lines Gi (1≦i≦m) so that the picture elements are caused to be in respective selected states. Note that the number of the gate drivers 12 can be determined arbitrarily, and therefore the number of gate driver 12 can be one. Moreover, each of the gate drivers 12 does not necessarily need to be in the form of a chip, and therefore the gate drivers 12 can be monolithically provided in the liquid crystal panel 11.

The source drivers 13 constitute a driving circuit for driving pixel columns, in which driving circuit the source drivers 13 are cascade-connected with each other. The source drivers 13 are provided in the vicinity of an edge of the liquid crystal panel 11, which edge is orthogonal to the edge at which the gate drivers 12 are provided. The source drivers 13 (i) receive, from the timing controller 14, (a) respective source driver control signals Scs each indicative of a source clock and a source start pulse and (b) respective video signals Da and (ii) sequentially supply, in response to the source driver control signals Scs, data signals to the respective source lines Sj (1≦j≦n) so that the data signals are written in the picture elements. The data signals, which have been supplied from the source drivers 13, are written into picture elements which are in their selected states.

The timing controller 14 includes a video signal receiving block 14a, a gamma correction block 14b, an overshooting correction block 14c, a video signal mapping block 14d, a video signal sending block 14e, and a source/gate driver control signal generating block 14f. In a case where the liquid crystal display device 1 is a television device, the timing controller 14 is, for example, provided at the back side of the liquid crystal panel 11 so as to be mounted on a control substrate.

The video signal receiving block 14a receives a video signal SD which is supplied to a liquid crystal module by the use of a sync signal SS. A liquid crystal module, which is provided in a television device, receives a video signal SD by mainly utilizing LVDS, which is a serial transmission standard.

The gamma correction block 14b carries out gamma correction with respect to an inputted video signal SD which indicates tones. The gamma correction is carried out as image processing for improving display quality of the liquid crystal module. The gamma correction includes (i) conversion of input tones, (ii) feed-through voltage compensation carried out in accordance with displayed location on a panel, and (iii) gamma conversion carried out for each colored data. By the gamma correction, the input tones are appropriately converted into separated gamma curves for dealing with various situations.

The overshooting correction block 14c carries out a process for overshoot driving, as image processing for improving display quality of the liquid crystal module. The process for overshoot driving will be described later in detail.

Note that image processing such as dithering by frame rate control (FRC) can be carried out as appropriate, in addition to the processes carried out by the gamma correction block 14b and the overshooting correction block 14c. Moreover, an order in which the image processings are carried out is not limited to that illustrated in FIG. 3, and therefore the order can be determined arbitrarily.

A line-buffer block can be further provided for temporarily storing video signals SD for several lines so as to adjust timings of (i) the video signals SD supplied to the liquid crystal module and (ii) signals supplied to the gate drivers 12 and the source drivers 13.

The video signal mapping block 14d carries out reconfiguration of video signals Da in accordance with the picture elements of the liquid crystal panel 11.

The video signal sending block 14e sends video signals Da to the respective source drivers 13. A liquid crystal module, which is provided in a television device, mainly utilizes mini-LVDS, which is a serial transmission standard.

The source/gate driver control signal generating block 14f generates signals for controlling the gate drivers 12 and the source drivers 13, such as the gate driver control signals Scg and the source driver control signals Scs.

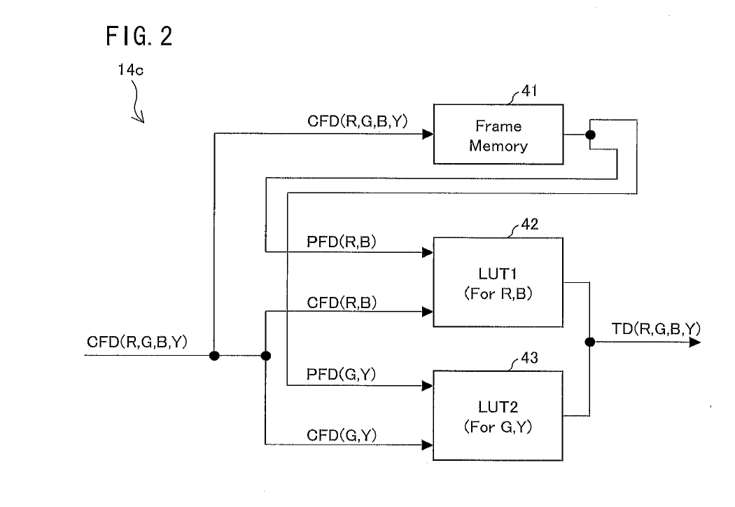

FIG. 2 shows a configuration of the overshooting correction block 14c.

The overshooting correction block 14c includes a frame memory 41, a first look-up table 42, and a second look-up table 43.

In a case where pieces of current frame display data CFD of respective R, G, B, and Y are supplied to the overshooting correction block 14c, (i) the pieces of current frame display data CFD of respective R and B are converted into respective pieces of output tone data in accordance with a correspondence described in the first look-up table 42 and (ii) the pieces of current frame display data CFD of respective G and Y are converted into respective pieces of output tone data in accordance with a correspondence described in the second look-up table 43. The first look-up table 42 causes pieces of output tone data corresponding to the red and blue picture elements to have overshooting amounts larger than those contained in pieces of output tone data corresponding to the green and yellow picture elements. This is because each of the red and blue picture elements has the picture element area larger than that of each of the green and yellow picture elements. The second look-up table 43 causes pieces of output tone data corresponding to the green and yellow picture elements to have overshooting amounts smaller than those contained in pieces of output tone data corresponding to the red and blue picture elements. This is because each of the green and yellow picture elements has the picture element area smaller than that of each of the red and blue picture elements.

The pieces of current frame display data CFD of respective R, G, B, and Y are stored in the frame memory 41. In an overshooting correction carried out with reference to the first look-up table 42 in a following frame, the pieces of current frame display data CFD of respective R and B, stored in the frame memory 41, are used as pieces of previous frame display data PFD of respective R and B. In an overshooting correction carried out with reference to the second look-up table 43 in a following frame, the pieces of current frame display data CFD of respective G and Y, stored in the frame memory 41, are used as pieces of previous frame display data PFD of respective G and Y.

An overshooting amount to be contained in output tone data is determined by comparing input tone data of the current frame with input tone data of the previous frame.

Pieces of target data TD of respective R, G, B, and Y are thus prepared by adding overshooting amounts to the respective pieces of current frame display data CFD of respective R, G, B, and Y and are then supplied, as the output tone data, to the video signal mapping block 14d.

By the processes in the overshooting correction block 14c, overshoot driving is carried out as shown in, for example, (a) and (b) of FIG. 1.

(a) and (b) of FIG. 1 show an example in which liquid crystal is driven such that a liquid crystal transmittance T0, which is obtained by applying a liquid crystal application voltage V0, is shifted to a liquid crystal transmittance T1 (here, T1>T0). In a case where no overshoot driving is carried out, a liquid crystal application voltage V1 (here, V1>V0) is applied to the liquid crystal during a first frame F1 and subsequent frames, in order to cause the liquid crystal to have the liquid crystal transmittance T1 corresponding to a steady state of a display. In a case where overshoot driving is carried out with reference to the first look-up table 42, (i) a liquid crystal application voltage Vos1 is applied to the liquid crystal during the first frame F1, and (ii) the liquid crystal application voltage V1 is applied to the liquid crystal during a second frame F2 and subsequent frames. In a case where overshoot driving is carried out with reference to the second look-up table 43, (i) a liquid crystal application voltage Vos2 is applied to the liquid crystal during the first frame F1, and (ii) the liquid crystal application voltage V1 is applied to the liquid crystal during the second frame F2 and subsequent frames. A relation of the liquid crystal application voltages is expressed by the following Inequality (1):

|Vos1−V1|>|Vos2−V1| (1)

In a case where V0>V1 and T0>T1, each of waveforms shown in (a) and (b) of FIG. 1 is turned upside down but the relation of Inequality (1) is not changed.

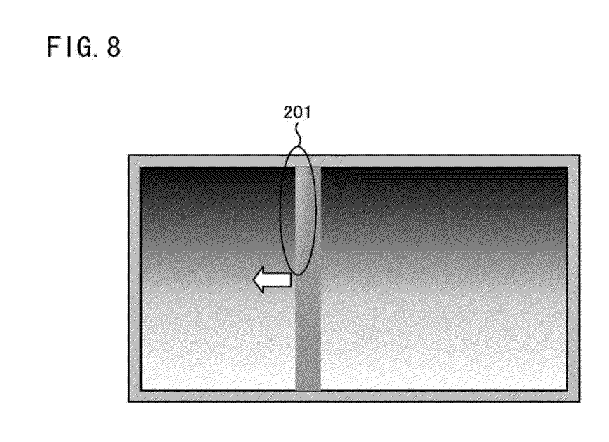

As a result, each of the picture elements PR and PB of R and B respectively that have larger picture element areas receive data signals corrected by adding thereto larger overshooting amounts compared with the picture elements PG and PY of G and Y respectively, and therefore the liquid crystal application voltage Vos1 is applied to liquid crystal corresponding to the picture elements PR and PB. This causes liquid crystal molecules corresponding to the picture elements PR and PB to have a response speed approximate to or identical with that of liquid crystal molecules corresponding to the picture elements PG and PY, and it is therefore possible to obtain substantially uniform response speeds in the picture elements PR, PG, PB, and PY in their display states (see (b) of FIG. 1). This allows suppression of the incorrect color balance described with reference to FIG. 8.

A liquid crystal application voltage is a difference between an electric potential of a picture element electrode (hereinafter, referred to as “picture element electrode potential”) and an electric potential of a counter electrode (hereinafter, referred to as “counter electrode potential”). In view of this, in regard to a picture element electrode potential with respect to a counter electrode potential, in a case where (i) a first picture element electrode potential is caused in response to a data signal generated with reference to the first look-up table 42, (ii) a second picture element electrode potential is caused in response to a data signal generated with reference to the second look-up table 43, and (iii) the first picture element electrode potential and the second picture element electrode potential have identical data polarities, a difference between the first picture element electrode potential and the counter electrode potential is larger than a difference between the second picture element electrode potential and the counter electrode potential.

An electric potential of the data signal (hereinafter, referred to as “data signal potential”) contains a feed-through voltage, and therefore the picture element electrode potential is lower than the data signal potential by substantially the electric potential corresponding to the feed-through voltage. In a case where each of the liquid crystal application voltages Vos1, Vos2, and V1 in Inequality (1) is substituted by a corresponding data signal potential, Inequality (1) cannot necessarily hold true, because a feed-through voltage varies depending on tone data and locations of the picture elements on the panel. However, in a case where (i) the liquid crystal application voltages Vos1, Vos2, and V1 have identical data polarities, (ii) a difference between a feed-through voltage generated in a picture element by the liquid crystal application voltage Vos1 and a feed-through voltage generated in the picture element by the liquid crystal application voltage V1 is sufficiently smaller than the liquid crystal application voltage Vos1, (iii) a difference between a feed-through voltage generated in a picture element by the liquid crystal application voltage Vos2 and a feed-through voltage generated in the picture element by the liquid crystal application voltage V1 is sufficiently smaller than the liquid crystal application voltage Vos2, and (iv) each of the liquid crystal application voltages Vos1, Vos2, and V1 is substituted by a corresponding data signal potential, Inequality (1) can be assumed to hold true.

In a case where (i) a first tone is displayed with the liquid crystal transmittance T0 and (ii) a second tone is displayed with the liquid crystal transmittance T1, the liquid crystal display device 1 can be assumed to have the following features, provided that Inequality (1) holds true when the each of the liquid crystal application voltages Vos1, Vos2, and V1 is substituted by a corresponding data signal potential.

In a case where display of a first tone (the liquid crystal transmittance T0) by the picture elements is shifted to display of a second tone (the liquid crystal transmittance T1) different from the first tone through a plurality of frames, within a range of input tone data (video signal SD) corresponding to the first tone and a range of input tone data (video signal SD) corresponding to the second tone, a picture element of a type with a larger picture element area exhibits, with respect to each data polarity, a larger difference (i.e., a difference between the liquid crystal application voltages Vos1 and V1 or between Vos2 and V1) in electric potential of a data signal corresponding to display of the second tone between an initial frame (the first frame F1) out of the plurality of frames and frames during which display is in a steady state (i.e., a state of the liquid crystal transmittance T1 during a third frame F3 and subsequent frames) out of the plurality of frames.

Namely, in the video signal SD indicative of the second input tone data for displaying the second tone (see FIG. 1), in a case where (i) a first difference is a difference between (a) a data signal potential corresponding to the liquid crystal application voltage Vos1 (in the picture elements PR and PB) and (b) a data signal potential corresponding to the liquid crystal application voltage V1 and (ii) a second difference is a difference between (a) a data signal potential corresponding to the liquid crystal application voltage Vos2 (in the picture elements PG and PY) and (b) the data signal potential corresponding to the liquid crystal application voltage V1, the first difference is larger than the second difference in each of positive and negative data polarities, (i) within a range of the second input tone data for displaying the second tone and (ii) within a range of the first input tone data, indicated by the video signal SD, for displaying the first tone.

In the example shown in FIG. 1, it is assumed that two types of picture element areas are employed. Note, however, that, the present embodiment is not limited to this. In a case where picture elements are classified by their sizes of picture element areas into a plurality of types, the picture elements can be classified into the plurality of types such that a picture element, which belongs to a type to which picture elements having larger picture element areas belong, causes a larger difference in electric potential between the liquid crystal application voltages. In a case where, for example, a relation of picture element areas of picture elements PR, PG, PB, and PY is R>B>>G>Y, the picture elements PR and PB can be classified into a first type and the picture elements PG and PY can be classified into a second type. In such a case, each of the picture elements PR and PB belonging to the first type causes a larger difference in electric potential between the liquid crystal application voltages, as compared to each of the picture elements PG and PY belonging to the second type. Alternatively, the following example is also encompassed in the scope of the present invention. That is, in a case where a relation of picture element areas of picture elements PR, PG, PB, and PY is R>B>G>Y, (i) the picture element PR is classified into a first type, the picture element PB is classified into a second type, and the picture elements PG and PY are classified into a third type and (ii) a relation of a difference in electric potential between the liquid crystal application voltages becomes the first type>the second type>the third type. In a case where picture elements of identical colors have different picture element areas, such a case is encompassed in the scope of the present invention, provided that the picture elements can be classified into types.

According to the present embodiment, the liquid crystal display device 1 has the picture elements PR, PG, PB, and PY, and identical colored picture elements belong to the same type. With the configuration, it is possible to carry out overshooting correction with respect to identical colored input tone data with reference to an identical look-up table. This allows data processing for each color to be easily carried out.

According to the present embodiment, the red picture elements and the blue picture elements belong to a same type; the green picture elements and the yellow picture elements belong to a same type; and each of the red picture elements and the blue picture elements has a picture element area larger than that of each of the green picture elements and the yellow picture elements. With the configuration, it is possible to appropriately reproduce an intended color range with colors R, G, B, and Y, without causing incorrect color balance.

According to the present embodiment, the red picture elements and the blue picture elements are provided in a first column; the green picture elements and the yellow picture elements are provided in a second column; and the first column is different from the second column. According to the configuration, the picture elements, which have identical or similar picture element areas are provided in the same column. With the configuration, in a case where the gate lines Gi are intended to be arranged at identical spacings, it is possible to set spacings between the source lines Sj to be efficient spacings which hardly cause blank areas.

With the configuration of the present embodiment, it is possible to prevent time lag of tone change in a transient response, by controlling liquid crystal molecules to have identical response speeds in all the picture elements. The present embodiment can therefore be applied to a simple color liquid crystal display device for a simple color display such as a monochrome display or a display only in red.

As above described, the liquid crystal display device of the present invention is a liquid crystal display device of an active matrix type, the liquid crystal display device including picture elements having different picture element areas in a display region, the picture elements being classified into a plurality of types depending on their picture element areas, in a case where display of a first tone by the picture elements is shifted to display of a second tone different from the first tone through a plurality of frames, within a range of input tone data corresponding to the first tone and a range of input tone data corresponding to the second tone, a picture element of a type with a larger picture element area exhibits, with respect to each data polarity, a larger difference in electric potential of a data signal corresponding to display of the second tone between an initial frame out of the plurality of frames and frames during which display is in a steady state out of the plurality of frames.

According to the configuration of the present invention, a picture element of a type with a larger picture element area receives a data signal corrected by adding thereto a larger overshooting amount, and a liquid crystal application voltage, corresponding to thus corrected data signal, is applied to liquid crystal corresponding to the picture element. With the configuration, it is possible to causes liquid crystal molecules corresponding to different types of picture elements to have approximate or identical response speeds, and it is therefore possible to obtain substantially uniform response speeds in all types of picture elements, which are in their display states. This allows suppression in the incorrect color balance when a gray display is carried out by a multicolor liquid crystal display device. Moreover, with the configuration of the present invention, it is possible to prevent time lag of tone change in a transient response, by controlling the liquid crystal molecules to have substantially uniform response speeds in all the picture elements. The present invention is therefore applicable to a simple color liquid crystal display device.

This brings about an effect of realizing a liquid crystal display device which can carry out overshoot driving in accordance with a picture element area.

According to the liquid crystal display device of the present invention, the picture elements are red picture elements, green picture elements, blue picture elements, and yellow picture elements; and picture elements of a same color belong to a same type.

With the configuration, it is possible to carry out overshooting correction with respect to identical colored input tone data with reference to an identical look-up table. This allows data processing for each color to be easily carried out.

According to the liquid crystal display device of the present invention, the red picture elements and the blue picture elements belong to a same type; the green picture elements and the yellow picture elements belong to a same type; and each of the red picture elements and the blue picture elements has a picture element area larger than that of each of the green picture elements and the yellow picture elements.

With the configuration, it is possible to appropriately reproduce an intended color range with colors R, G, B, and Y, without causing incorrect color balance.

According to the liquid crystal display device of the present invention, the red picture elements and the blue picture elements are provided in a first column; the green picture elements and the yellow picture elements are provided in a second column; and the first column is different from the second column.

According to the configuration, the picture elements, which have identical or similar picture element areas are provided in the same column. With the configuration, in a case where the gate lines are intended to be arranged at identical spacings, it is possible to set spacings between the source lines to be efficient spacings which hardly cause blank areas.

A method of the present invention for driving a liquid crystal display device is a method for driving a liquid crystal display device of an active matrix type, the liquid crystal display device including picture elements having different picture element areas in a display region, the method including the step of: setting a relation among (i) first input tone data corresponding to a first tone, (ii) second input tone data corresponding to a second tone, and (iii) a difference in electric potential of a data signal corresponding to display of the second tone between an initial frame out of the plurality of frames and frames during which display is in a steady state out of the plurality of frames, in such a manner that the picture elements are classified into a plurality of types depending on their picture element areas, the classification of the picture elements being carried out such that, in a case where display of the first tone by the picture elements is shifted to display of the second tone different from the first tone through a plurality of frames, a picture element of a type with a larger picture element area exhibits, with respect to each data polarity, a larger difference in electric potential of the data signal corresponding to display of the second tone between the initial frame out of the plurality of frames and the frames during which display is in a steady state out of the plurality of frames.

According to the method of the present invention, a picture element of a type with a larger picture element area receives a data signal corrected by adding thereto a larger overshooting amount, and a liquid crystal application voltage, corresponding to thus corrected data signal, is applied to liquid crystal corresponding to the picture element. With the configuration, it is possible to causes liquid crystal molecules corresponding to different types of picture elements to have approximate or identical response speeds, and it is therefore possible to obtain substantially uniform response speeds in all types of picture elements, which are in their display states. This allows suppression in the incorrect color balance when a gray display is carried out by a multicolor liquid crystal display device. Moreover, with the method of the present invention, it is possible to prevent time lag of tone change in a transient response, by controlling the liquid crystal molecules to have substantially uniform response speeds in all the picture elements. The present invention is therefore applicable to a simple color liquid crystal display device.

This brings about an effect of realizing a method for driving a liquid crystal display device which can carry out overshoot driving in accordance with a picture element area.

According to the method of the present invention, the display region has red picture elements, green picture elements, blue picture elements, and yellow picture elements; and picture elements of a same color belong to a same type.

With the configuration, it is possible to carry out overshooting correction with respect to identical colored input tone data with reference to an identical look-up table. This allows data processing for each color to be easily carried out.

According to the method of the present invention, the red picture elements and the blue picture elements belong to a same type; the green picture elements and the yellow picture elements belong to a same type; and each of the red picture elements and the blue picture elements has a picture element area larger than that of each of the green picture elements and the yellow picture elements.

With the configuration, it is possible to appropriately reproduce an intended color range with colors R, G, B, and Y, without causing incorrect color balance.

According to the method of the present invention, the red picture elements and the blue picture elements are provided in a first column; the green picture elements and the yellow picture elements are provided in a second column; and the first column is different from the second column.

According to the configuration, the picture elements, which have identical or similar picture element areas are provided in the same column. With the configuration, in a case where the gate lines are intended to be arranged at identical spacings, it is possible to set spacings between the source lines to be efficient spacings which hardly cause blank areas.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention is suitably applicable to an active matrix liquid crystal display device such as a television device.

### REFERENCE SIGNS LIST

1: Liquid crystal display device
T0: Liquid crystal transmittance (first tone display)
T1: Liquid crystal transmittance (second tone display)
SD: Video signal (input tone data)
F1: First frame (initial frame)

1. A liquid crystal display device of an active matrix type, comprising picture elements having different picture element areas in a display region, the picture elements being classified into a plurality of types depending on their picture element areas,
in a case where display of a first tone by the picture elements is shifted to display of a second tone different from the first tone through a plurality of frames,
within a range of input tone data corresponding to the first tone and a range of input tone data corresponding to the second tone, a picture element of a type with a larger picture element area exhibits, with respect to each data polarity, a larger difference in electric potential of a data signal corresponding to display of the second tone between an initial frame out of the plurality of frames and frames during which display is in a steady state out of the plurality of frames.

2. The liquid crystal display device as set forth in claim 1, wherein:
the picture elements are red picture elements, green picture elements, blue picture elements, and yellow picture elements; and
picture elements of a same color belong to a same type.

3. The liquid crystal display device as set forth in claim 2, wherein:
the red picture elements and the blue picture elements belong to a same type; the green picture elements and the yellow picture elements belong to a same type; and
each of the red picture elements and the blue picture elements has a picture

4. The liquid crystal display device as set forth in claim 2, wherein:
the red picture elements and the blue picture elements are provided in a first column;
the green picture elements and the yellow picture elements are provided in a second column; and
the first column is different from the second column.

5. A method for driving a liquid crystal display device of an active matrix type, said liquid crystal display device including picture elements having different picture element areas in a display region, said method comprising the step of:
setting a relation among (i) first input tone data corresponding to a first tone, (ii) second input tone data corresponding to a second tone, and (iii) a difference in electric potential of a data signal corresponding to display of the second tone between an initial frame out of the plurality of frames and frames during which display is in a steady state out of the plurality of frames, in such a manner that the picture elements are classified into a plurality of types depending on their picture element areas,
the classification of the picture elements being carried out such that, in a case where display of the first tone by the picture elements is shifted to display of the second tone different from the first tone through a plurality of frames, a picture element of a type with a larger picture element area exhibits, with respect to each data polarity, a larger difference in electric potential of the data signal corresponding to display of the second tone between the initial frame out of the plurality of frames and the frames during which display is in a steady state out of the plurality of frames.

6. The method as set forth in claim 5, wherein:
the display region has red picture elements, green picture elements, blue picture elements, and yellow picture elements; and picture elements of a same color belong to a same type.

7. The method as set forth in claim 6, wherein:
the red picture elements and the blue picture elements belong to a same type; the green picture elements and the yellow picture elements belong to a same type; and
each of the red picture elements and the blue picture elements has a picture element area larger than that of each of the green picture elements and the yellow picture elements.

8. The method as set forth in claim 6, wherein:
the red picture elements and the blue picture elements are provided in a first column;
the green picture elements and the yellow picture elements are provided in a second column; and
the first column is different from the second column.
